(19) United States
(12) Patent Application Publication
(10) Pub. No.: US 2003/0004598 A1
(43) Pub. Date: Jan. 2, 2003

(54) Apparatus and method for facilities maintenance management

(76) Inventor: Martin M. Morris, Marietta, GA (US)

Correspondence Address: CARL M. DAVIS II, BAKER , DONELSON, BEARMAN & CALDWELL, 5 CONCOURSE PARKWAY, SUITE 900, ATLANTA, GA, 30328, US

(21) Appl. No.: 09/871,097

(22) Filed: May 31, 2001

(51) Int. Cl. G06F 19/00; G06F 7/00

(52) U.S. Cl. 700/116; 700/95; 700/115; 700/226; 700/215

(57) ABSTRACT

An apparatus providing identification, monitoring, and tracking of facilities maintenance in which an interactive information storage device receives and retains at least one facility profile that includes a facility identification, at least one process area descriptor and with at least one substrate associated with each process area descriptor. Each substrate includes a substrate condition, a substrate environment, a substrate process priority, and a substrate area. An analyzer evaluates the substrate condition, the substrate environment, and the substrate process priority to determine a substrate ranking. An estimator applies standard work information to the substrate condition, the substrate environment, the substrate process priority, and the substrate area, to determine a substrate maintenance estimate. A reporter generates maintenance specifications of the substrate maintenance estimates and substrate ranking for a selected one of the facility profiles. A method of identifying, monitoring, and tracking of facilities maintenance is disclosed.

### TECHNICAL FIELD

The present application relates to managing the maintenance of facilities. More particularly, the present invention is directed to apparatus and methods for identifying, evaluating, specifying, scheduling, monitoring, and controlling facilities maintenance.

### BACKGROUND OF THE INVENTION

Buildings are complicated structures erected to provide shelter for offices, apartments, warehouses and storage spaces and the like. Buildings used in industry, such as office space, warehouse, and manufacturing facilities, are commonly referred to as the physical plant or “the facilities”. The facilities include a number of separate components including foundations, support walls, roof trusses, interior walls, wall panels, wall coverings, and ceilings. Also, the facilities include the mechanical and electrical systems. The mechanical systems include water and waste water piping, and fixtures such as water heaters, sinks and faucets, and the like, and the heating and ventilating (HVAC) system that includes the heating and cooling apparatus as well as blowers, filter apparatus, and ducts. The electrical system includes wiring, lighting, controls, and so forth.

Periodically, these building components and structures require maintenance. Maintenance includes periodic inspection and evaluation of the operating equipment, the building components, structures, and coverings, as well as repair, replacement, and reconstruction of these components. For example, HVAC systems require routine inspection of the operating equipment, replacement of filter devices, and oiling and inspecting of blowers and belts operating the blowers. Painted surfaces typically require repainting at periodic intervals. Structural elements require inspection for corrosion and coating to resist corrosion.

For large building complexes, there are many hundreds, if not more, of separate items that require inspection, evaluation, and monitoring. Often, however, maintenance management has involved the maintenance and repair of items that become damaged, corroded or otherwise reach a failure point, without significant efforts at anticipating maintenance requirements and projecting expenses. For example, it may be less expensive to repair or replace an item prior to failure than to wait until the occurrence of failure before making the repair or replacement. In another aspect, the priority of the building component for assuring the ongoing operation of the activities within the building are such that waiting until failure is operationally impossible. On the other hand, some building components are both low in priority and low in maintenance cost that significant attention to the status of the particular building component is not cost effective.

Accordingly, there remains a need in the art for an apparatus and method for management facilities maintenance including identifying, monitoring and controlling maintenance functions, scheduling and budgeting. It is to such that the present invention is directed.

### BRIEF DESCRIPTION OF THE PRESENT INVENTION

The present invention meets the need in the art by providing an apparatus and method that identifies, monitors, and tracks facilities maintenance. The apparatus comprises an interactive information storage device configured for receiving and retaining at least one facility profile. The facility profile includes a facility identification, at least one process area descriptor and at least one substrate associated with each process area descriptor. Associated with each substrate is a substrate condition, a substrate environment, a substrate process priority, and a substrate area. An analyzer evaluates the substrate condition, substrate environment, and substrate process priority to determine a substrate ranking. An estimator applies standard work information to the substrate condition, substrate environment, substrate process priority, and substrate area, to determine substrate maintenance estimates. A reporter generates maintenance specifications of the substrate maintenance estimates and substrate ranking for a selected one of the facility profiles.

In another aspect, the present invention provides a method for identifying, monitoring, and tracking of facilities maintenance, comprising the steps of:

(a) subdividing a facility into separate process areas;

(b) identifying within each process area at least one substrate together with a substrate condition, a substrate environment, and a substrate process priority area;

(c) analyzing the substrate condition, substrate environment, and substrate process priority to determine a substrate ranking; and

(d) generating maintenance specifications using a substrate maintenance estimates and substrate ranking for a selected one of the facilities.

Other objects, features, and advantages of the present invention will become apparent from a reading of the following detailed description of the invention and claims in view of the appended drawings.

### BRIEF DESCRIPTION OF THE DRAWINGS

FIG. 1 illustrates a schematic view of an apparatus according to the present invention for facilities management.

FIG. 2 is a detailed schematic illustration of the facilities management apparatus illustrated in FIG. 1.

FIG. 3 is a screen display for entry of a client having at least one facility for maintenance management using the facilities maintenance management apparatus illustrated in FIG. 2.

FIG. 4 is a screen display for accessing and editing information about facilities to be managed in the apparatus shown in FIG. 2.

FIG. 5 is a screen display for entry of a facility for maintenance management using the facilities maintenance management apparatus illustrated in FIG. 2.

FIG. 6 is a screen display for entry of a process associated with the facility for maintenance management illustrated in FIG. 5.

FIG. 7 is a screen display for accessing and editing process area information for the process area shown in FIG. 6.

FIG. 8 is a screen display for accessing and editing substrate information associated with a process area in FIG. 6.

FIG. 9 is a screen display for entry of a substrate associated with the process for maintenance management illustrated in FIG. 8.

FIG. 10 is a screen display for entry of maintenance history associated with each facility substrate for maintenance management using the facilities maintenance management apparatus illustrated in FIG. 2.

FIG. 11 is a screen display for selecting and generating reports.

FIG. 12 is a screen display for substrate factor costs for use in preparing maintenance estimates for maintenance management using the facilities maintenance management apparatus illustrated in FIG. 2.

FIG. 13 is a screen display for substrate specification for use in preparing maintenance bids using the facilities maintenance management apparatus illustrated in FIG. 2.

FIG. 14 is a schematic view of the operation at the facilities maintenance management apparatus.

### DETAILED DESCRIPTION OF THE PREFERRED EMBODIMENTS

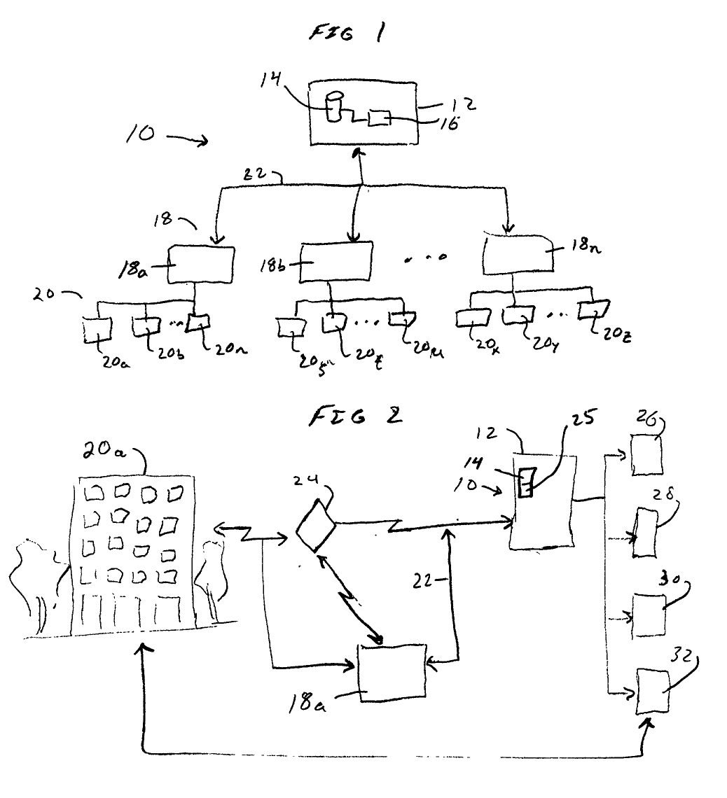

Referring now in more detail to the drawings, in which like numerals indicate like parts throughout the several views, FIG. 1 illustrates a schematic view of an apparatus 10 according to the present invention for facilities maintenance management. The facilities management apparatus 10 includes a computer device 12 having an interactive information storage device 14 and a communications interface 16 for coordinating communication with the computer device 12 and at least one manager generally 18 of a facility generally 20. In the illustrated embodiment, a plurality of facilities managers 18a, 18b, and 18n communicate with the computer device 12 through a telecommunications channel 22. The communications channel 22 includes conventional telecommunications, computer network, world wide web, cable, and the like, providing two-way communication of information.

Each facility manager 18 is responsible for maintaining the physical plant of at least one facility 20. In the illustrated embodiment, the facility manager 18a manages facilities 20a, 20b, and 20n; the facilities manager 18b maintains facilities 20s, 20t and 20u; the facility manager 18n maintains facilities 20x, 20y and 20z. In an alternate embodiment, (not illustrated), the facilities manager 18 maintains the computer device 12 and operates the facilities apparatus 10 directly using a conventional personal computer and input devices, keyboard, mouse, and the like, rather than communicating through the communications channel 22.

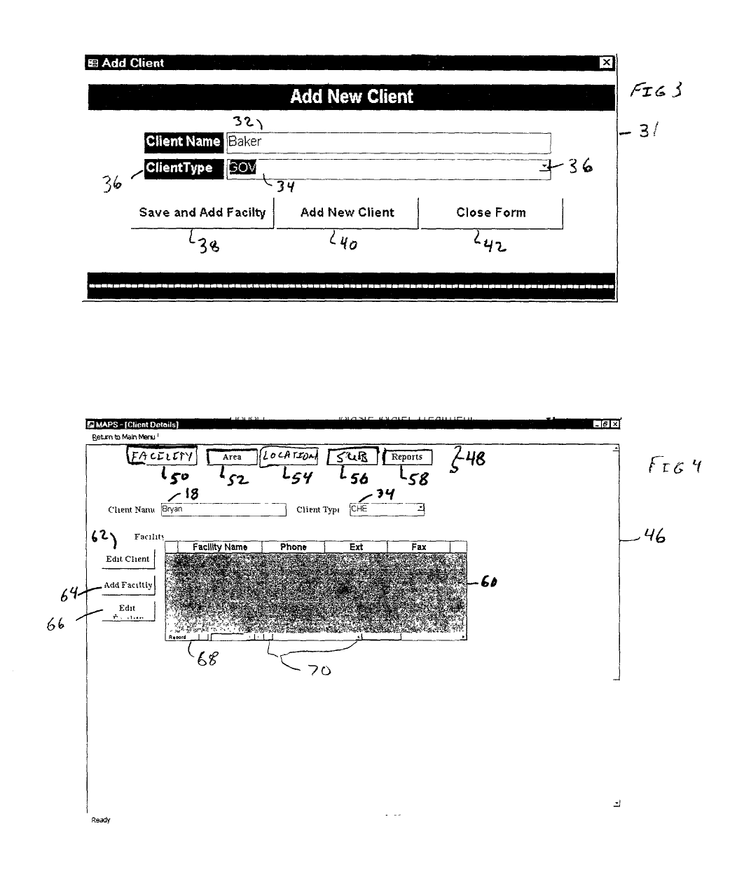

FIG. 2 is a detailed schematic illustration of facilities management apparatus 10 illustrated in FIG. 1. In FIG. 2, the facility manger 18a is responsible for facility 20a. Through an inspector 24, the facility 20a is evaluated, and profile information 25 about the facility is communicated 22 to the facilities management apparatus 10 on the computer device 12. The inspector 24 can be an internal element of the facilities manager 18, or can be an independent agency providing inspection and maintenance services. The facility profile information 25 is accessed in the storage device 14.

The apparatus 10 includes an analyzer 26 for evaluating information about the facility 20. An estimator 28 applies work information 27 to the facility profile information 25 to determine substrate maintenance estimates. A reporter 29 generates maintenance specifications with the substrate maintenance estimates and a substrate ranking for the facility 20. The reports are used by the facility manager 18 for scheduling, bidding, and monitoring maintenance activities, generally 31.

FIG. 3 is a screen display 33 for entry of information about a client or facilities manager 18 having at least one facility 20 for maintenance management using the facilities maintenance management apparatus 10 illustrated in FIG. 2. The display screen 33 includes an entry field 32 for the name of the facilities manager 18 as well as the type 34 of the facilities manager 18. A pull-down menu 36 is provided in order to select the type of facility manager. For example, the following Table 1 lists some facility types, but is not an exhaustive list. In this embodiment, the client type is a three letter abbreviation of a defined facility manager type.

TABLE 1

| Type Code | Definition |
|---|---|
| GOV | Government |
| FAB | Food and beverage |
| CHE | Chemical |
| PAP | Pulp and paper |
| PET | Petroleum |
| POW | Power |
| TEX | Textile |
| WWT | Waste Water Treatment |

A button 38 saves and adds the new facility manager 18 to the information storage device 14. A button 40 brings up a blank screen 31 for adding a new facility manager 18. A button 42 closes the screen display 30. Closing the display screen 31 returns control to a central main menu (not illustrated) for accessing the various features of the facility management apparatus 10.

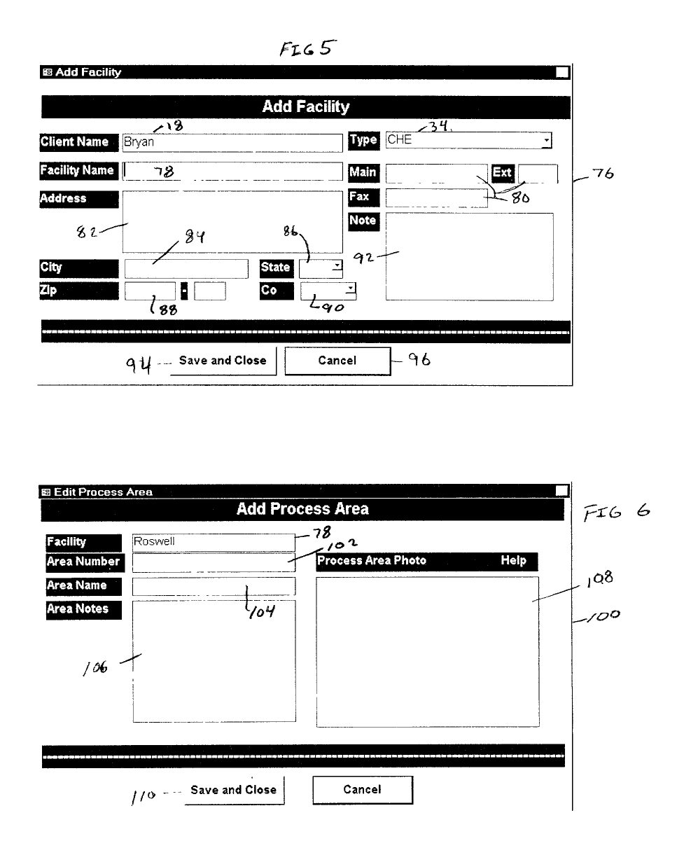

FIG. 4 illustrates a display screen 46 for accessing facility manager 18 and facility 20 information. The display screen 46 includes access buttons generally 48 for accessing information display screens operable with the facilities management apparatus 10. A button 50 directs the apparatus 10 to add or edit facility information which is displayed on FIG. 4. A button 52 directs the apparatus 10 to add or edit area information. A button 54 directs the apparatus 10 to add or edit location information. A button 56 directs the apparatus 10 to add or edit substrate information. A button 58 directs the apparatus 10 to generate reports. These are discussed separately below.

The screen 46 displays the particular facility manager 18 under examination as well as the facility type 34. A window 60 lists the particular facilities 20 associated with the facility manager 18. A button 62 directs the management apparatus 10 to edit the selected facility manager 18. Upon its activation, control transfers to an edit window similar to FIG. 3 for editing information about the facility manager 18. A button 64 directs the apparatus 10 to add an additional facility to the particular facility manager 18. A button 66 directs the apparatus 10 to edit the facility information which is displayed in window 60. Control information generally 68 in the window 60 identifies the particular record in the storage device 14 being examined. Control arrows 70 provide left and right movement for displaying in the window 60 the information about the particular facility. Similar controls are used in display screens discussed below and are not otherwise specifically discussed, although illustrated.

FIG. 5 is a screen display for entry of a facility 20 for maintenance management using the facilities maintenance management apparatus 10 illustrated in FIG. 2. The display screen 76 includes the facility manager name 18 and the type 34. A name field 78 allows entry of the name of the particular facility. A phone number field 80 provides for a main phone number and extension as well as a fax number. An address field 82 provides for the street address and location as well as the city 84, state 86, zip code 88 and country 90. A notes field 92 allows entering notes or comments about the facility 20, its location, or other facility-related information. A button 94 permits saving the information and closing the window 76 to return to the control window 46 illustrated in FIG. 4. A cancel button 96 cancels entry of the information. It is noted that a window similar to 76 is presented when the edit button 66 on the screen 46 in FIG. 4 is activated. In the edit mode, all of the currently available information about the facility in question is presented in the fields described above. Changes are made by entering the new information in the appropriate field and pressing the save and close button 94.

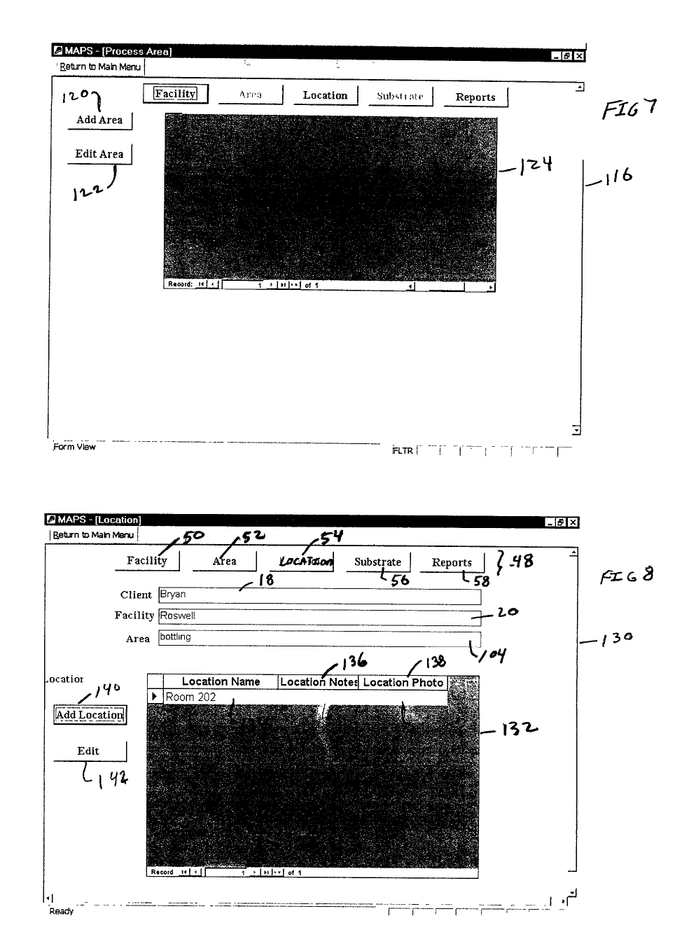

FIG. 6 is a screen display 100 for entry of a process area 104 associated with the facility 20 for maintenance management illustrated in FIG. 6. The process area 104 is a broad functional description, such as “office”, “warehouse”, “manufacturing”, and can be detailed such as “cutting department”, “painting”, and “finishing”, as examples. The display screen 100 includes the facility name 78. An area number 102 and an area name 104 identifies the particular process area of the facility 78. A notes field 106 allows entry of notes about the process area 104. A process area photo 108 also can be included. A button 110 provides for saving the information about the added process area and closing the window 100 to return to a process area control window illustrated in FIG. 7. Activation of the area button 52 presents the screen 116 illustrated in FIG. 7. An add button 120 directs the apparatus 10 to add an additional process area for the particular facility. An edit area button 122 directs the apparatus 10 to edit a selected area for the particular facility. A window 124 displays all of the process areas associated with a particular facility.

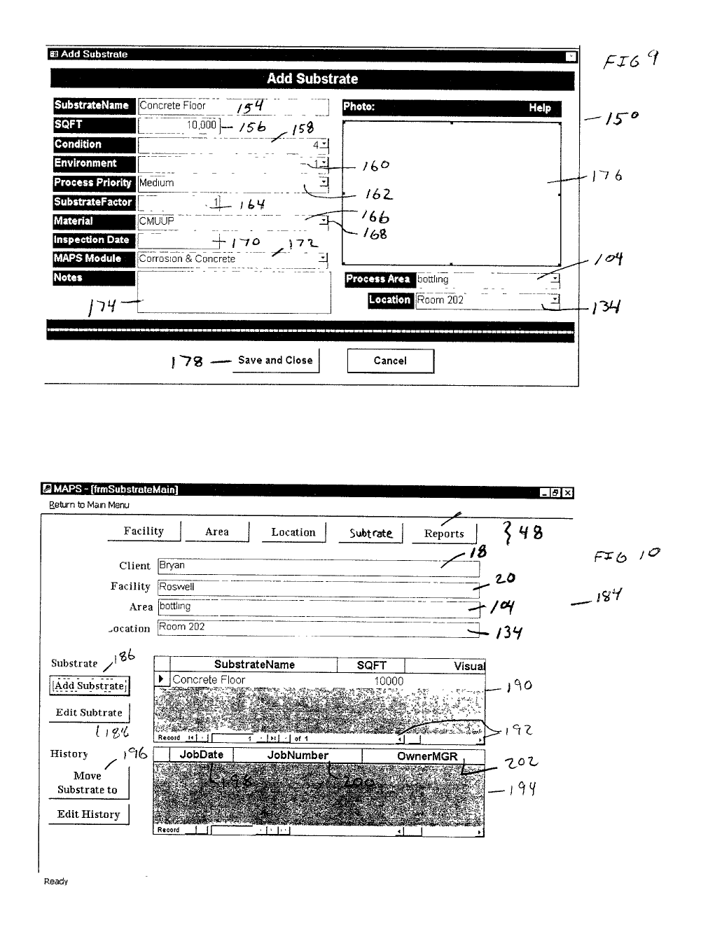

FIG. 8 is a screen display 130 for entry of location 131 information about the particular process area 104. The window 130 includes the control buttons generally 48 for transferring controls to facility, area, location, or substrate menus. The window 130 also displays the client 18, the particular facility 20, and the process area 104 in question. A location window 132 includes fields for the name of the location 134, notes 136 about the location, and a location photo 138. An add button 140 permits adding location information for the area 104 while an edit button 142 allows the apparatus 10 to edit the particular selected location information displayed in the window 132.

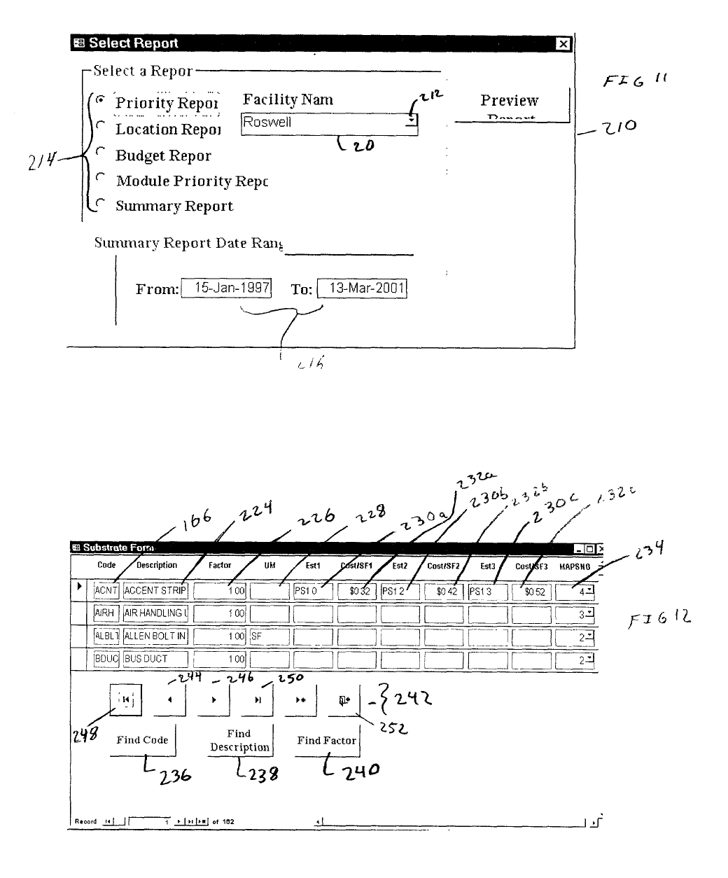

FIG. 9 is a screen display 150 for entry of a substrate 152 associated with the process area 104 for maintenance management illustrated in FIG. 6. The screen 150 includes a substrate name 154 with its square footage 156. Upon investigation, a condition 158 is assigned for the substrate 154. The condition in the illustrated embodiment is a factor describing the current condition of the particular substrate. In the illustrated embodiment, four levels of condition are used, as reported below in Table 2.

TABLE 2

| Condition | Definition |
|---|---|
| Replace | Complete failure of |
| | asset protection |
| Restore | Signs of failure |
| | (cumbrance is less than |
| | 30 percent degradation, |
| | but restoration of the |
| | asset protection is |
| | feasible) |
| Preventive | Minor indication of |
| Maintenance | attack, no failure |
| World Class | No indication of |
| | attack or failure |

An environment button 160 defines the environmental location of the substrate. In the illustrated embodiment, the environment is selected from Table 3 shown below.

TABLE 3
ENVIRONMENT OP SUBSTRATE

| Environment | |
|---|---|
| Class | Definition |
| 1. | Interior surface with inter- |
| | mittent contact or no direct |
| | contact with adverse conditions |
| 2. | Exterior condition with normal |
| | annual weather conditions but |
| | without direct contact to process |
| 3. | Surface with contact with process |
| | chemicals or gasses, temperature, |
| | etc. |
| 4. | Surface submerged/contained |
| | within process chemicals or |
| | gasses |

Also associated with the substrate is the process priority 162. The process priority provides an indication as to the degree of criticality for the substrate with respect to the process under examination. The process priority values are shown below in Table 4.

TABLE 4
PROCESS PRIORITY

| Priority Class | Description |
|---|---|
| Low | Appearance purposes only |
| Medium | Item is related, but not |
| | critical, to the process |
| | system |
| High | Item is critically related to |
| | the process system in that |
| | it's failure could directly |
| | impact the process system |
| Urgent | Immediate attention required |
| | due to a particular safety or |
| | process concern |

Each substrate 154 includes a substrate factor 164. This factor describes the difficulty of the design of the substrate. For example, a flat substrate has a rating of one. The substrate factor is used in evaluating the priority and complexity of maintenance services.

The substrate material is entered using a code. The code can be obtained from a pull-down window using the arrow 168. The material pull-down window (not shown) includes a code associated with each material type and a definition.

A date field 170 indicates the date of the inspection. A module 172 is assigned to each substrate. A notes field 174 allows entry of notes and other information related to the particular substrate involved. A photograph 176 of the substrate may be provided. The process area 104 and the location 134 are likewise displayed on the screen 150. A button 178 permits saving the substrate information and closing the substrate window 150. Substrate information may be edited also using a window similar to 150 in which all the information is displayed. Information to be changed can be entered to the appropriate field and the save and close button 178 pressed.

FIG. 10 is a display window 184 providing control for adding and editing substrates upon activation of buttons 186 or 188. The substrates associated with the process area 104 are displayed in the window 190. Arrow buttons 192 conventionally allow the user to move the display of information shown in the display window 190. The window 184 shown in FIG. 10 also provides for substrate history generally 194. A button 196 enables moving the substrate information to a history record. Subsequently, new information about the substrate would be added using the button 186. In this way, historical records about maintenance jobs including job date 198, a job number 200, and the entity 202 providing the maintenance services can be tracked, together with the information about the substrate 154 and its condition at the time the maintenance services were performed.

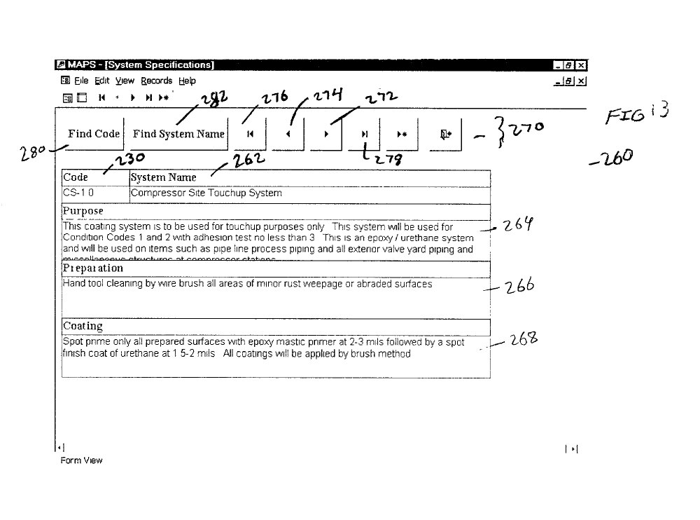

FIG. 11 illustrates a display window 210 activated when the reports button 58 is selected. The facility name 20 is displayed and using a drop-down menu 212 other facilities can be selected. Various reports can be obtained by selecting from a table 214. These reports include priority for maintenance, location reports, budget reports, module priority report and a summary report. A date range 216 can be selected.

FIG. 12 illustrates substrate factor costs for maintenance estimates. The substrate factor cost 220 includes the material code 166 and definition 224. A material factor 226 is provided together with a unit of measure 228 for the particular material. Each substrate includes a reference to a process specification for doing work on the type of substrate. In the illustrated embodiment, three process specifications 230a, 230b, and 230c are provided. These process specifications correspond to appropriate code sections. These are discussed below. Associated with each process specification 230a, 230b, and 230c is a cost 232a, 232b, and 232c per square foot for performing the process specification.

A find code button 236 facilitates searching of the database for particular substrate codes. The substrate information can also be located by a description activated by button 238. A find factor button 240 locates substrates of particular factor values. Control buttons generally 242 allow the substrate database to be searched using forward and back arrows 244, 246 or beginning of file 248, end of file 250 and close 252.

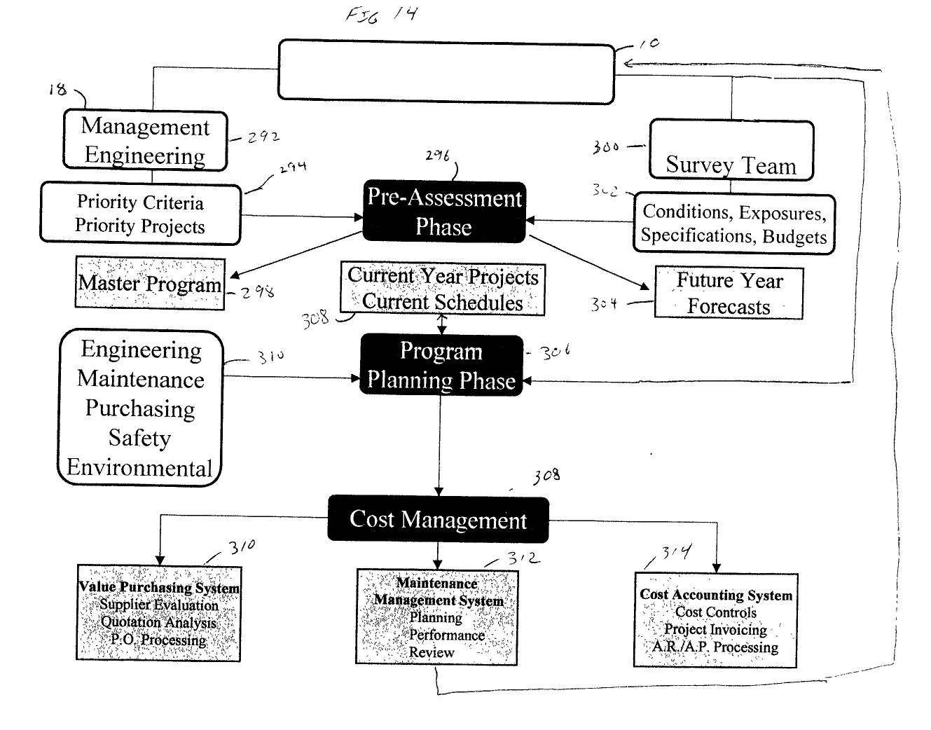

FIG. 13 is a screen display 260 for substrate specification for use in preparing maintenance bids using the facilities maintenance management apparatus illustrated in FIG. 2. The screen display 260 includes process specification information including the code 230 and the description 262 associated with the process 104 and the code 230. The specification includes the purpose 264, the preparation 266 required to undertake the specification and a description 268 to be accomplished. Control button generally 270 allow tracking through the process specifications with forward and back keys 272, 274 respectively, beginning of file 276 and end of file 278 buttons. A find code button 280 allows entry of particular code numbers to reach the appropriate specification. Alternatively, the system name can be entered using button 282. Although not illustrated, the screen 260 similarly allows adding or editing specifications using appropriate control buttons.

FIG. 14 is a schematic view of an operation of the facilities maintenance management apparatus 10 discussed above. The facility manager 18 provides management and engineering services 292 for each facility generally 20. For each facility, the personnel in management and engineering services 292 identifies projects 294, including the priority criteria and priority of the projects. This information is considered in a pre-assessment phase 296 which leads to a master program 298 for management of the facility 20. In addition, the facilities management apparatus 10 communicates with an inspector team 300 generally associated with the inspector 24. The survey team 300 examines the facility 20 as to conditions and exposures, as discussed below, generally 302. The inspector 24 further provides information as to maintenance specifications 230, 262 and budgeted expenses 232 associated with the specifications. The survey team 300 communicates its findings to the management and engineering services 292 for evaluation and use in the pre-assessment phase 296. In addition to the master program 298, which results from the pre-assessment phase 296, future year forecasts can be made, for example by extrapolating the conditions and exposure evaluations 302.

With the master program 298 in mind, the facilities maintenance management apparatus 10 further provides a program planning phase 306. Current year maintenance projects and current year schedules, generally 308, are derived from the planning phase 306. The program planning phase 306 communicates with the various departments of the facility manager 18, including engineering, maintenance, purchasing, safety, and environmental, generally 310. The planning phase also communicates with cost management 312 which is directed to purchasing 314 of necessary maintenance services and materials for the facility 20. In addition, management supervision 312 is enabled for planning of the maintenance projects, for performance of the maintenance projects, and for review of the maintenance projects. Finally, the cost management function 308 provides information for cost accounting 316, including cost controls, project invoicing, and accounts receivable/accounts payable processing. The review function communicates back to the facilities maintenance management program 10 whereby the resulting improvements are updated to the tracking feature of the maintenance apparatus 10. The updated information is then communicated to the master program 298 for use in developing future year forecasts and upon occurrence, development of then-current year projects and schedules.

In the practice of the facility maintenance system of the present invention, each facility 20 is subdivided into manageable components. The facility is first subdivided into process areas 104 using industrial definitions. Each area 104 is identified by an industrial definition, such as office, warehouse, production space, and the like. Each area 104 includes one or more locations 131 which are portions or rooms within the area. For example, the office process area can include locations such as office, file room, copy room, and the like. Within each location 131 are one or more substrates 152. Substrates 152 are construction materials, coverings, flooring, ceiling tile, and the like building components of the location. Factors associated with the substrate 152 are the condition 158, the environment 160, and the process priority 162. These factors are used in a weighted analysis of the substrate in order to arrive at a substrate ranking.

With reference to FIGS. 1, 2, and 3, the facility manager 18 identifies the facility 20 to be managed for maintenance, together with the facility type. With reference to FIGS. 4 and 5, facility-specific information is added to the maintenance apparatus 10, or edited, using the buttons 62 or 66. This includes the facility name 78, address 82, and contact phone number 80.

The inspector 24 conducts a visual and quantitative inspection of the process area 104 and the substrates 152 in the various locations 143 in the process areas. With reference to FIGS. 6 and 7, the process areas 104 are defined and notes 92 and 106, and photos 108 or the process area 104 can be added. With reference to FIG. 8, specific location information 130 is added. Substrates 152 in each process area 104 are identified using the screen in FIG. 9. The inspector 24 determines the condition 158 and square foot area 156 for each substrate 152. While Table 2 above is qualitative for analysis purposes, a numerical indicator is applied for evaluation and recording purposes. The environment of the substrate is identified and a process priority 162 is assigned, based on the degree of criticality that the substrate holds with respect to the process. As shown in Table 4 above, the process priority provides an indication as to the criticality of the substrate with respect to the process. The substrate factor which is a reflection of the difficulty of maintaining the substrate is assigned. Substrate material information is entered, together with the date 170, notes 172, and photograph 176. The substrate material code 166 cross-indexes to the substrate factor costs accessible through the screen shown in FIG. 12. Depending on the substrate condition (see Table 2 above), three values of material cost 232 per square foot is provided for performing the process specifications 230. The process specifications 230 correspond to the substrate specifications such as those illustrated in FIG. 13.

The analyzer 26 generates priority rankings for the substrates. In the illustrated embodiment, the priority maintenance ranking is determined by evaluating the condition at 30 percent, the environment at 20 percent and the priority at 50 percent. As discussed above, these qualitative assessments are assigned a numerical value in a range of 1 to 4 inclusive. The resulting sum of this evaluation is divided by four and multiplied by 100 to give a priority ranking in a 1-100 range. The higher value of the ranking indicates more significant criticality of the substrate relative to the process with which it is associated.

The resulting priority provides criticality rankings of the substrates 152, and thus indirectly the priorities of the process areas 104. The facility manager 18 can thereby prioritize attention, inspection, and maintenance activities to assure that critical substrates 152 in critical process areas 104 are monitored and maintained.

The apparatus 10 further provides substrate maintenance estimates. The estimator 28 applies work information 27 to the facility profile information 25. The substrate condition 158, represented as a numerical quantity, cross-indexes to the respective costs 232a, 232b, or 232c required for performing the process specification 230 in order to maintain the substrate 152 in question. The resulting cost data information is gainfully used by the facility manager 18 in preparing annual budgets for maintenance activities involving the facility 20. Likewise the substrate maintenance estimate can be used to compare and evaluate bids from contractors for performing the required substrate maintenance. In addition, the cross-indexed process specification or description 262 is associated with the process 104 and the process code 230. This feature of the apparatus 10 provides a specification including the purpose 264, the preparation 266, and the description 268 of the work to be accomplished for maintaining the substrate. The apparatus 10 accordingly provides a consistent description of the process activities required to maintain the substrate 152, so that contractors bidding on maintenance work are provided uniform specifications.

The apparatus 10, likewise, permits monitoring and evaluation over an extended period of time. As the maintenance work is performed, the appropriate substrate condition and priority may be re-characterized. With respect to FIG. 10, substrate information is moved by enabling button 196 in order to transfer prior substrate status to a history record. The substrate condition can then be updated to reflect the maintenance on the substrate. As shown in FIG. 10, window 184 also provides for substrate history generally 194 including the job date 198, job number 200, and the entity 202 providing this service. In this way, the apparatus 10 of the present invention provides a look-back feature associated with each substrate. This provides a historical record useful for tracking the activities for that substrate as well as the capacity of the contractor to provide the maintenance service. In this way, the apparatus 10 provides feedback from prior experience for the facility manager 18 at the facility 20. Based on the feedback of the new condition following the maintenance, the analyzer 24 can re-determine priorities for effectively managing and tracking maintenance of facilities 20.

While it is contemplated that the storage device 14 and the computer device 12 be accessible at a central location through the communications interface to one or more facility managers 18 tracking and monitoring maintenance activities at one or more facilities 20.

The present invention accordingly provides an apparatus that identifies, evaluates, specifies, schedules, monitors, and controls maintenance activities associated with the physical plant of facilities with feedback from maintenance activities that revise the condition, environment, and priority of the facility for these functions, for future tracking and evaluation. The principles, preferred embodiments, and modes of operation of the present invention have been described in the foregoing specification. The invention is not to be construed as limited to the particular forms disclosed because these are regarded as illustrative rather than restrictive. Moreover, variations and changes may be made by those skilled in the art without departure from the spirit of the invention as described by the following claims.

What is claimed is:

1. An apparatus providing identification, monitoring, and tracking of facilities maintenance, comprising:
an interactive information storage device configured for receiving and retaining at least one facility profile, said facility profile including a facility identification, at least one process area descriptor, at least one substrate associated with each process area descriptor, and associated with each substrate a substrate condition, a substrate environment, a substrate process priority, and a substrate area;
an analyzer for evaluating said substrate condition, substrate environment, and substrate process priority to determine a substrate ranking;
an estimator for applying standard work information to the substrate condition, substrate environment, substrate process priority, and substrate area to determine a substrate maintenance estimate;
a reporter for generating maintenance specifications of the substrate maintenance estimates and substrate ranking for a selected one of the facility profiles.

2. The apparatus as recited in claim 1, wherein said interactive information storage device comprises a remotely located first computer device accessible through an interactive computer network by at least one second computer device associated with said facility profile.

3. The apparatus as recited in claim 1, further comprising a substrate maintenance specification associated with each different type of substrate, said substrate maintenance specification comprising at least a maintenance purpose, a maintenance preparation, and a maintenance coating, for specifying maintenance tasks and bidding thereon.

4. The apparatus as recited in claim 3, further comprising a bid generator for preparing maintenance services requests based on selected substrates and said associated substrate maintenance specification.

5. The apparatus as recited in claim 1, further comprising at least one substrate maintenance history for at least one of said substrates, each substrate maintenance history comprising a job identification, a job notes, and a job cost, for tracking maintenance projects for said substrate.

6. The apparatus as recited in claim 1, wherein said reporter generates an evaluation for a selected one of the substrates based on said substrate maintenance history and said substrate maintenance estimate.

7. The apparatus as recited in claim 1, wherein said substrate further comprises a substrate factor based on said substrate maintenance history.

8. A method for identifying, monitoring, and tracking of facilities maintenance, comprising the steps of:
(a) subdividing a facility into separate process areas;
(b) identifying within each process area at least one substrate together with a substrate condition, a substrate environment, and a substrate process priority area;
(c) analyzing the substrate condition, substrate environment, and substrate process priority to determine a substrate ranking;
(d) generating maintenance specifications using a substrate maintenance estimates and substrate ranking for a selected one of the facilities.

9. The method as recited in claim 8, further comprising the step of maintaining the process area and substrate information on an interactive information storage device.

10. The method as recited in claim 9, where maintenance specifications performed on substrates revise the substrate information contained on the interactive information storage device.

11. The method as recited in claim 10, wherein the interactive information storage device is operated by a remote first computer device accessed through an interactive computer network by at least one second computer device associated with said facility.

12. The method as recited in claim 1, further comprising the step of providing at least one substrate maintenance specification associated with each different type of substrate, said substrate maintenance specification comprising at least a maintenance purpose, a maintenance preparation, and a maintenance coating, for specifying maintenance tasks and bidding thereon.

13. The method as recited in claim 12, further comprising the step of generating maintenance bid specifications for obtaining maintenance services based on selected substrates and said associated substrate maintenance specification.

14. The method as recited in claim 13, further comprising the steps of completing at least one substrate maintenance project, copying the prior information about the substrate to a substrate history, and editing the substrate information to reflect changes based on the maintenance project.

15. The method as recited in claim 14, further comprising for at least one of said substrates, the steps of maintaining in each substrate maintenance history a job identification, a job notes, and a job cost, for tracking maintenance projects for said substrate.

16. The apparatus as recited in claim 8, comprising the step of generating an evaluation for a selected one of the substrates based on said substrate maintenance history and said substrate maintenance estimate.
